(19) United States
(12) Patent Application Publication
(10) Pub. No.: US 2004/0172333 A1
(43) Pub. Date: Sep. 2, 2004

(54) Method for purchasing goods and services in business-to-business (B-2-B) transactions

(76) Inventors: George E. Siviy, Webster, NY (US); Brent Pavicic, Rochester, NY (US); Robert C. DeClerck, Webster, NY (US); Christopher C. Keaton, Rochester, NY (US)

Correspondence Address: Thomas H. Close, Patent Legal Staff, Eastman Kodak Company, 343 State Street, Rochester, NY, 14650-2201, US

(21) Appl. No.: 10/376,541

(22) Filed: Feb. 28, 2003

(51) Int. Cl. G06F 17/60

(52) U.S. Cl. 705/16

(57) ABSTRACT

A method for purchasing goods and services in business-to-business transactions, the method includes the steps of providing a first database having attributes related to purchasable goods or services maintained and purchasable by a first party; and providing a second database having attributes related to at least a portion of the goods and services purchasable by the first party and primarily maintained by a second party and electrically connected to the first database; wherein changes implemented on either the first or second databases are synchronized to each other; generating a purchase order by the first party from the first material database based on the attributes in the first material database; and transmitting the purchase order to the second party.

### FIELD OF THE INVENTION

The invention relates generally to the field of purchasing commodities via at least two computer databases that may be run by different application programs and respectively modifiable by the supplier and purchaser. More particularly, the invention relates to such databases that are synchronized so that consistency of the databases are maintained which, in turn, permits purchase requisitions generated from the purchaser database and submitted to the supplier to have correct information.

### BACKGROUND OF THE INVENTION

Computer databases are well known in the art for containing data that is retrievable and modifiable by a user. Still further, in large computing systems, there are numerous databases for various purposes that contain overlapping data in different data structures and the like. In most instances, the data is manually updated in both databases so that consistency and the integrity of the databases are maintained.

In business-to-business (i.e., B-2-B) transactions, commodity information is usually maintained by both the purchaser and supplier in separate databases. Purchase requisitions may or may not be generated from the purchaser database. In the case in which purchase requisitions are generated from the purchaser database, data is often incorrect due to the fact that some data may have changed, such as price, part number, and the like.

Consequently, a need exists for database synchronization of supplier and purchaser databases so that purchase order errors are minimized. Obviously, the labor required to correct such errors is enormous when accumulated over a period of time. This consequently adds cost to the price of goods and services to the everyday consumer who ultimately buys from the purchaser. Obviously, this adds to inflation which, in a weak economy, is even more undesirable.

### SUMMARY OF THE INVENTION

The present invention is directed to overcoming one or more of the problems set forth above. Briefly summarized, according to one aspect of the present invention, the invention resides in a method for purchasing goods and services in business-to-business transactions, the method includes the steps of (a) providing a first database having attributes related to purchasable goods or services maintained and purchasable by a first party; and (b) providing a second database having attributes related to at least a portion of the goods and services purchasable by the first party and primarily maintained by a second party and electrically connected to the first database; wherein changes implemented on either the first or second databases are synchronized to each other; (c) generating a purchase order by the first party from the first material database based on the attributes in the first material database; and (d) transmitting the purchase order to the second party.

These and other aspects, objects, features and advantages of the present invention will be more clearly understood and appreciated from a review of the following detailed description of the preferred embodiments and appended claims, and by reference to the accompanying drawings.

Advantageous Effect of the Invention

The present invention has the advantage of permitting automated synchronization of independent databases in B-2-B transactions so that purchase order errors are minimized.

### BRIEF DESCRIPTION OF THE DRAWINGS

FIG. 1 is an overview drawing of the B-2-B purchasing system having automated database synchronization of the present invention; and

FIG. 2 is a drawing illustrating exemplary data included in the databases.

### DETAILED DESCRIPTION OF THE INVENTION

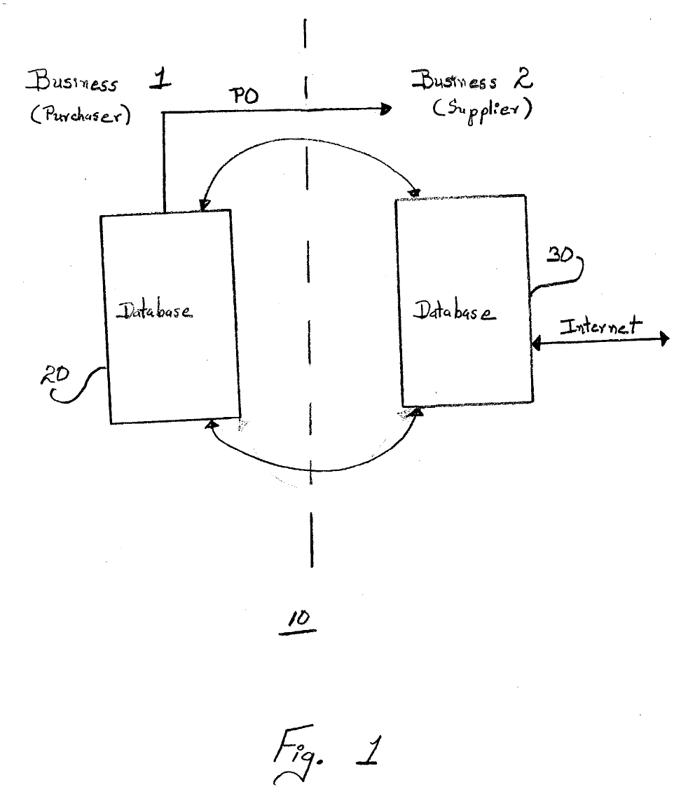

Referring to FIG. 1, the purchasing system 10 having database synchronization of the present invention is illustrated. A material master database 20 includes data needed for purchasing of goods and services, typically those needed by businesses for their day-to-day operations and manufacturing operations. This database 20 is maintained by the purchaser in the preferred embodiment. A material catalog database 30 includes data that is substantially the same data as in the material master database 20 and is typically maintained and updated by the supplier. It should be noted, that although the material master database 30 is maintained by the supplier, in some instances it may be partially or wholly maintained by the purchaser. The material catalog database 30 and the material master database 20 are electronically connected for permitting data synchronization. The material catalog database 30 is also connected to the Internet for permitting suppliers of the goods and services in the database 30 to update the data remotely. It should be readily recognized that this remote updating is advantageous and efficient for both the supplier and business.

In the ordinary course of business, when a good or service is needed by the business, a purchase order (PO) is generated (as illustrated by the arrow), preferably by automated means, using, in part, data from the material master database 20. This purchase order may then be sent electronically (via the Internet) or manually to the supplier. It should be readily apparent that maintaining updated data, such as price, availability, part numbers and the like, is essential to efficient purchasing operations.

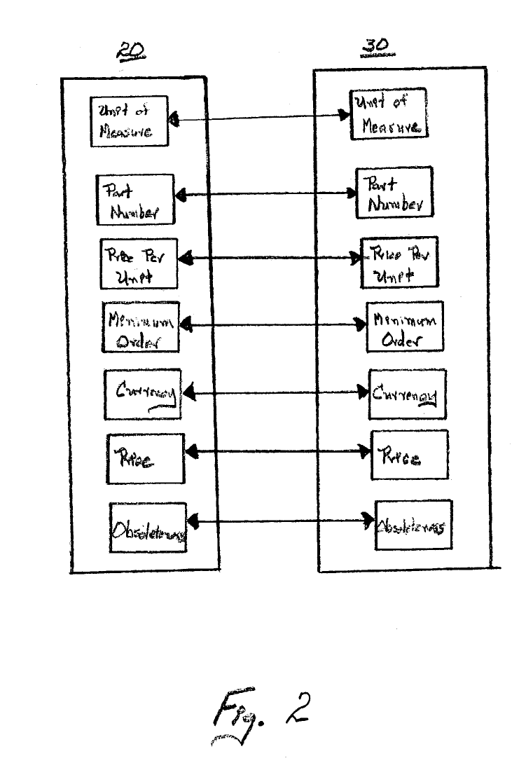

Referring to FIG. 2, there are shown the databases 20 and 30 of FIG. 1. The databases 20 and 30 include data such as unit of measure, supplier part number, price per unit, minimum order, currency, price and obsoleteness. It is noted that these databases 20 and 30 may be operated by different application programs having different field structures and the like for the data. For example, one may use six bits of information with only letter characters including blank spaces, and the other may use 8 bits of information using both letters and numbers with no blank spaces. Therefore, translation of the data is needed in order for updated data in one database to update data in the other database. This is accomplished by middleware software of the present invention. Such a middleware program may be created by those skilled in the art given the parameters specified in FIG. 2 and the corresponding text. As stated above, the supplier may update the database 30 via the Internet so that manual labor is minimized.

It should be noted that the purchaser may add checkpoints in the middleware so that, before synchronization, the purchaser can accept or reject data from the material catalogue. For example, the price may be checked so that pre-agreed or contractual obligations are accurately reflected in the update.

The invention has been described with reference to a preferred embodiment. However, it will be appreciated that variations and modifications can be effected by a person of ordinary skill in the art without departing from the scope of the invention.

### PARTS LIST

10 purchasing system

20 material master database

30 material catalog database

What is claimed is:

1. A method for purchasing goods and services in business-to-business transactions, the method comprising the steps of:
(a) providing a first database having attributes related to purchasable goods or services maintained and purchasable by a first party; and
(b) providing a second database having attributes related to at least a portion of the goods and services purchasable by the first party and primarily maintained by a second party and electrically connected to the first database; wherein changes implemented on either the first or second databases are synchronized to each other;
(c) generating a purchase order by the first party from the first material database based on the attributes in the first material database; and
(d) transmitting the purchase order to the second party.

2. The method of claim 1 further comprising the step of providing a middleware program for synchronization of the first and second databases.

3. The method as in claim 1 further connecting the second database to the Internet so that changes can be implemented remotely by a person outside an enterprise of the first party.

4. The method as in claim 1 further comprising the step of providing the first and second databases with different data structures.

5. The method as in claim 1, wherein either the first or second database is a portion of an electronic catalog system.

6. The method as in claim 1 further comprising the step of providing either individually or in any combination price, currency, minimum order, price per unit, part number as the attributes in the first and second databases.

7. The method as in claim 1, wherein the transmitting step includes electronically transmitting the purchase order.

8. A system for purchasing goods and services in business-to-business transactions, the system comprising:
(a) a first material database having attributes related to purchasable goods or services maintained and purchasable by a first party;
(b) a second material database having attributes related to at least a portion of the goods and services purchasable by the first party and primarily maintained by a second party and electrically connected to the first database; wherein changes implemented on either the first or second databases are synchronized to each other; and
(c) a purchase order generated by the first party from the first material database based on the attributes in the first material database; wherein the purchase order is transmitted to the second party.

9. The system of claim 8 further comprising a middleware program for synchronization of the first and second databases.

10. The system as in claim 8 further the second database connected to the Internet so that changes can be implemented remotely by a person outside an enterprise of the first party.

11. The system as in claim 8, wherein the first and second databases have different data structures.

12. The system as in claim 8, wherein either the first or second database is a portion of an electronic catalog system.

13. The system as in claim 8, wherein the attributes in the first and second databases include either individually or in any combination price, currency, minimum order, price per unit, part number.

14. The system as in claim 8, wherein the purchase order is electronically transmitted.
